(19) United States
(12) Patent Application Publication
(10) Pub. No.: US 2014/0366442 A1
(43) Pub. Date: Dec. 18, 2014

(54) APPARATUS TO CULTIVATE PLANTS

(71) Applicants: Weidong Song, Woodinville, WA (US); Fei Song, Woodinville, WA (US)

(72) Inventors: WEIDONG SONG, Woodinville, WA (US); Fei Wang, Woodinville, WA (US)

(21) Appl. No.: 13/919,847

(22) Filed: Jun. 17, 2013

(51) Int. Cl. A01G 9/02

(52) U.S. Cl. CPC A01G 9/02
USPC 47/66.7; 47/65.5

(57) ABSTRACT

This disclosure teaches an apparatus for cultivating plants that reduces the amount of lost water and increases the amount of water in the soil.

### CROSS-REFERENCES TO RELATED APPLICATIONS

Not Applicable

### STATEMENT REGARDING FEDERALLY SPONSORED RESEARCH OR DEVELOPMENT

Not Applicable

### INCORPORATION-BY-REFERENCE OF MATERIAL SUBMITTED ON A COMPACT DISC

Not Applicable

### SUMMARY OF THE INVENTION

Container gardening is the practice of growing plants in containers. The container garden has been used for house plants, starting crops, planting in places where space is limited (e.g. urban locations), or where the soil or climate is unsuitable for a particular plant or crop. Generally, these containers are made from terracotta, plastics or other composites.

No matter the type of container, keeping plants properly watered is a difficult task because of soil properties. Soil forms a structure filled with pore spaces. As soil settles, it becomes difficult for water to penetrate exposed soil surfaces, and pore space is reduced inside the soil. Because of the reduction of pore space, there are fewer spaces where water can reside. Referring to FIGS. 1a and 1b, when soil settles, a boundary, in the form of an air gap, is formed in between the soil and the container. This issue becomes more pronounced if the soil is allowed to dry entirely prior to watering. Added water will run through the container too quickly for the soil or roots of the plant to absorb. If the soil could be saturated with water by filling the remaining pore space with water, there would be more available water for plants. The invention, described herein, teaches an apparatus and method to break the air gap allowing the soil to absorb more water before water is lost through the drain hole located at the base of the container. Consequently, more water is available for plant roots to absorb and water loss is reduced.

### BRIEF DESCRIPTION OF THE DRAWINGS

Other features and advantages of the present invention will become apparent in the following detailed descriptions of the preferred embodiment with reference to the accompanying drawings, of which:

FIG. 1a is a perspective view of the container known in the art;

FIG. 1b is a cross-sectional view of the container, taken at A-A of FIG. 1a, showing soil profile;

FIG. 2a is a perspective view of a preferred embodiment of the instant container;

FIG. 2b, is a cross-sectional view of the instant container, taken at B-B of FIG. 2a, showing the flange in an open position;

FIG. 2c, is a cross-sectional view of the instant container, taken at B-B of FIG. 2a, showing the flange in a closed position;

FIG. 2d is a cross-sectional view of a plurality of the instant container, taken at B-B of FIG. 2a, stacked;

FIG. 3a is a perspective view of the flange attachment;

FIG. 3b shows a cross-sectional view of the flange attachment, taken from C-C of FIG. 3a;

FIG. 3c is an exploded view of the flange attachment being placed into a container.

FIG. 3d is a perspective view of the flange attachment as it is mated to a container;

FIG. 3e is a cross sectional view, taken from D-D of FIG. 3d, showing the flange attachment mated with a container.

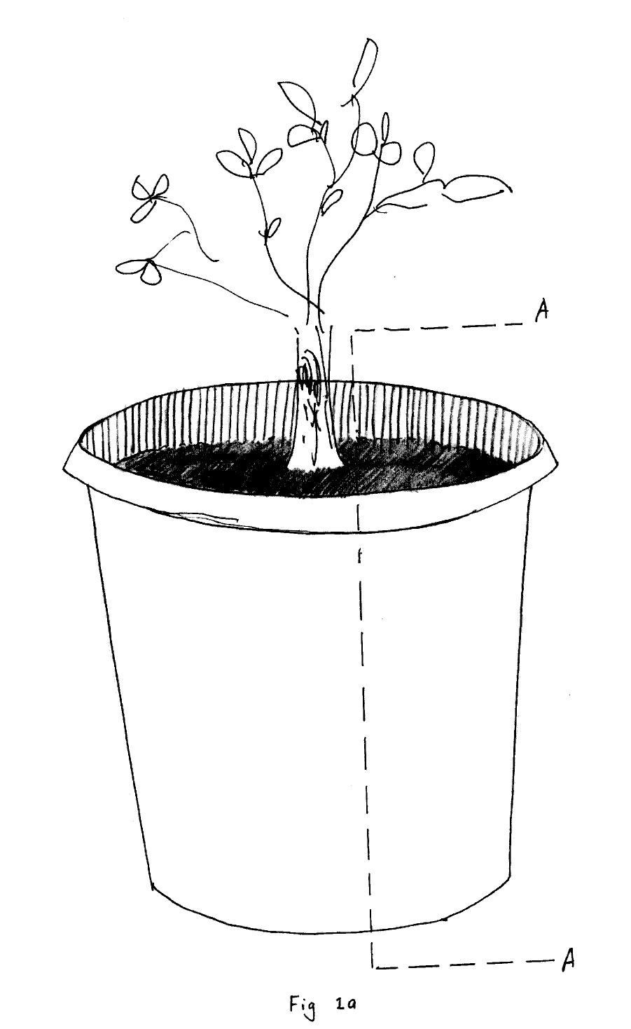

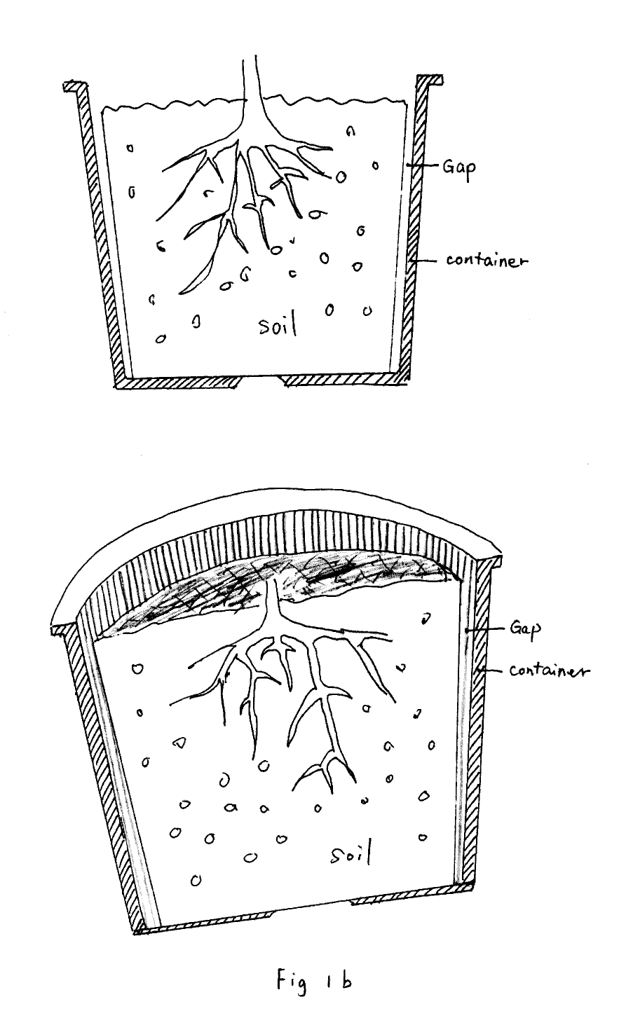

### DETAILED DESCRIPTION OF THE INVENTION

In the description of the invention above and in the detailed description of the invention, and the claims below, and in the accompanying drawings, reference is made to particular features of the invention. It is to be understood that the disclosure of the invention in this specification includes all possible combinations of such particular features. For example, where a particular feature is disclosed in the context of a particular aspect or embodiment of the invention, or a particular claim, that feature can also be used, to the extent possible, in combination with and/or in the context of other particular aspects and embodiments of the invention, and in the invention generally.

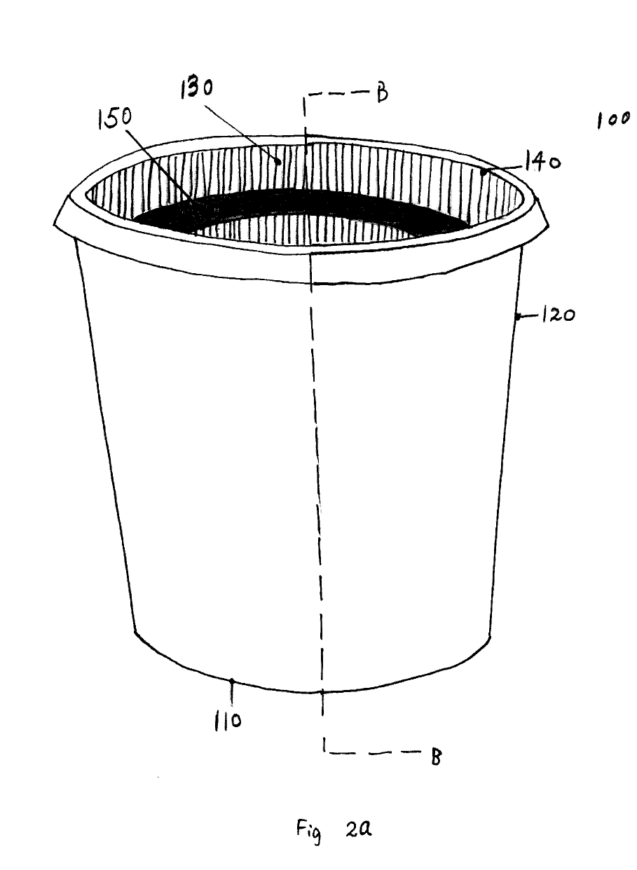

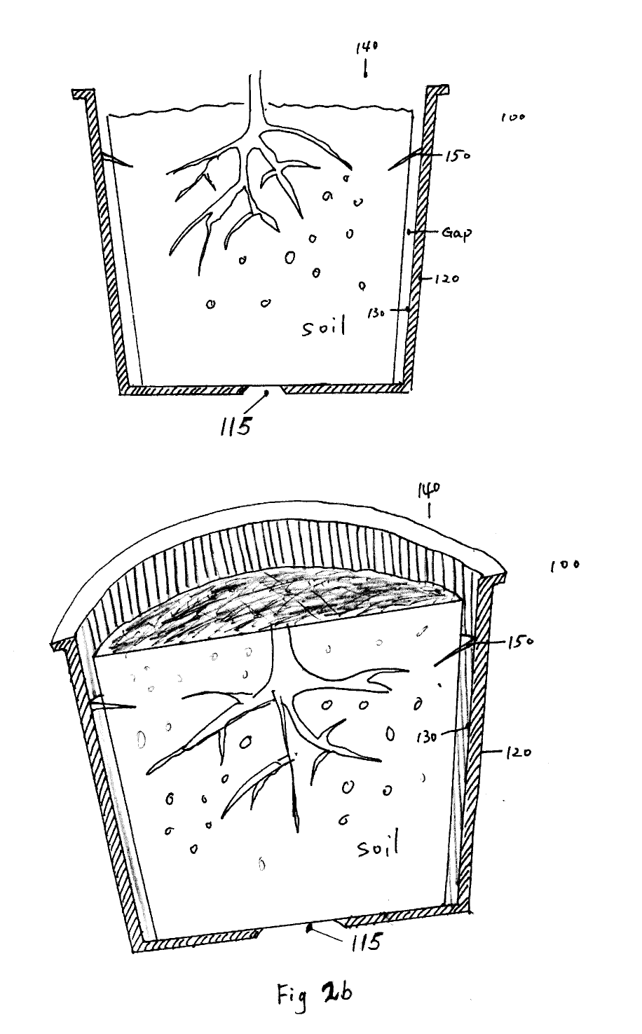

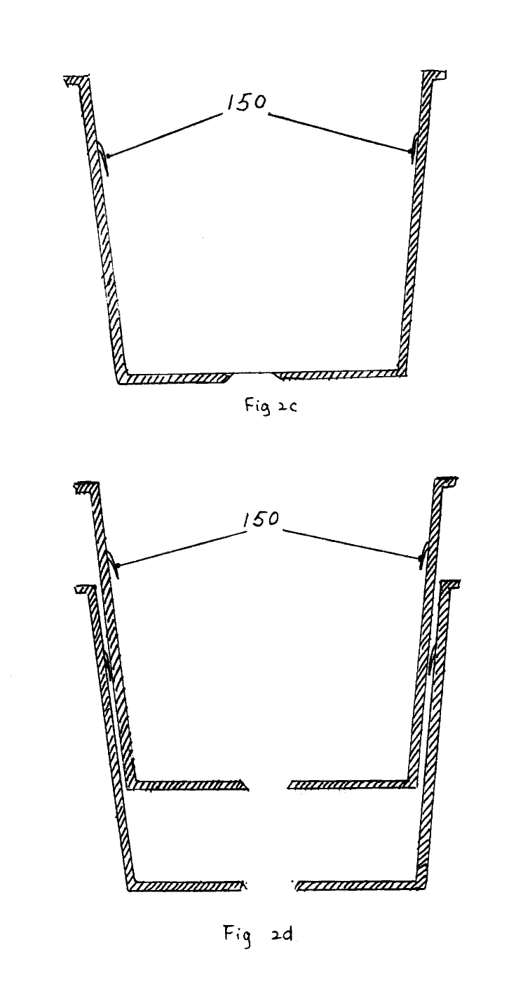

Referring to FIGS. 2a and 2b, the container (100) comprises a base (110) with a drain hole (115), substantially upstanding sidewalls (120), interior sidewall surface (130), and a substantially open top (140). In a first preferred embodiment, the container further comprises a flange (150) which is, either fixedly or flexibly, attached to the interior sidewall surface (130). Referring to FIGS. 2c and 2d, if the flange (150) is flexibly attached to the interior sidewall surface (130), the flange (150) can be flexed into a closed position so that containers can be stacked together. The flange (150) can be placed in the closed position by flexing it towards the substantially open top (140) or towards the base (110).

To use the container in the instant where the flange (150) is flexibly attached to the interior sidewall surface (130), soil is filled into the container (100) to a level just below the flange (150), and then the flange (150) is placed in the open position. Soil is then added above the level of the flange (150). To use the container (100) in the instant where the flange (150) is fixedly attached to the interior sidewall surface (130), soil should be added so that it surrounds both sides of the flange (150). Preferably, the flange (150) is made of a thin, flexible material such as plastic. However, a person having ordinary skill in the art will understand that the flange (150) can be made of any material.

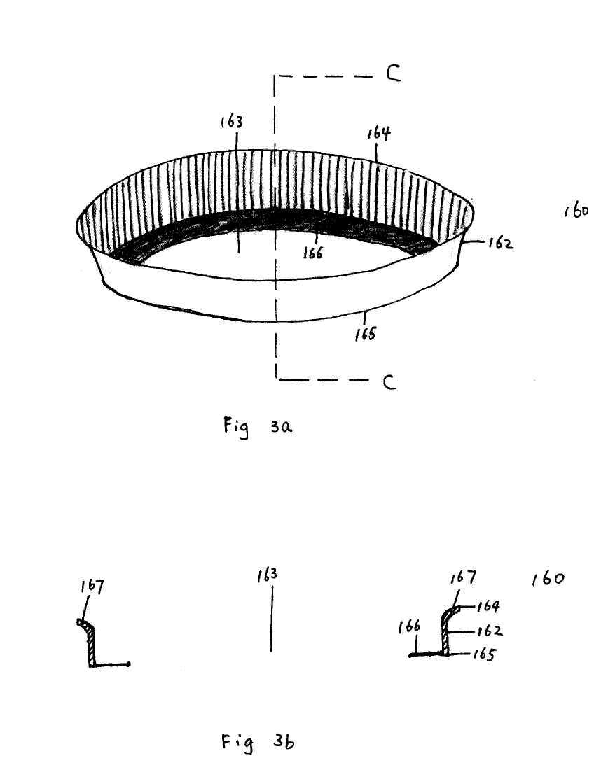

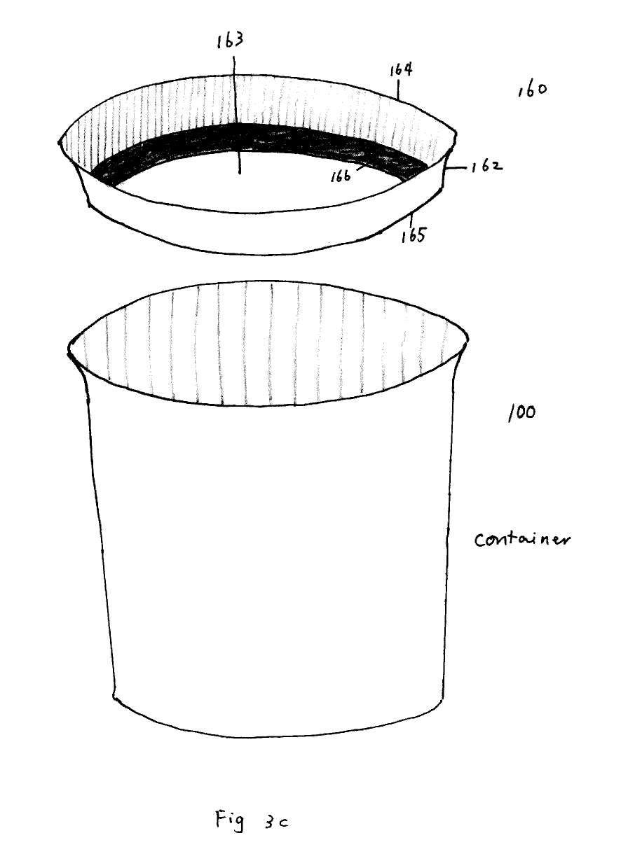

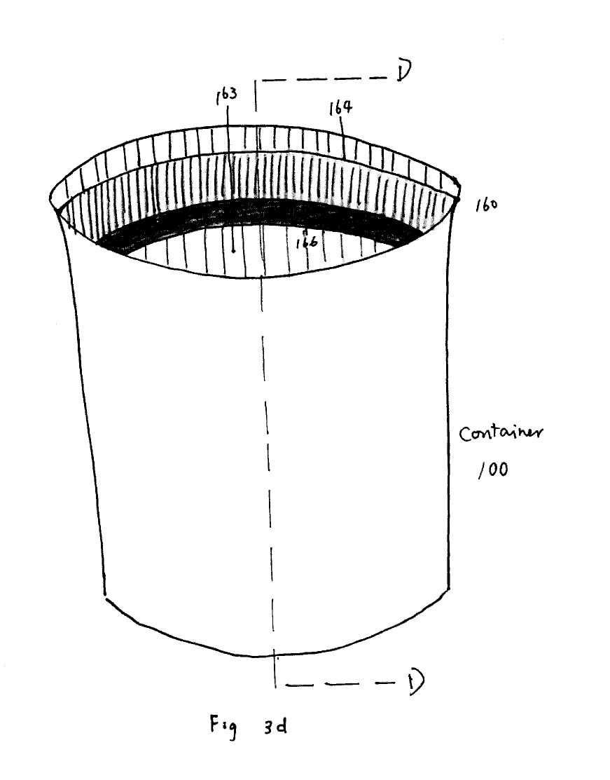

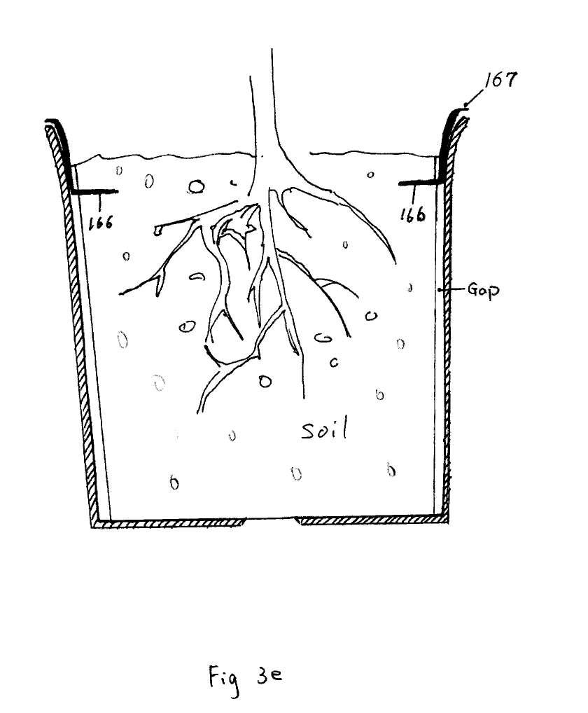

Referring to FIGS. 3a-3e, in a second preferred embodiment, a flange attachment (160) is provided which can be either fixedly or removeably attached to the interior sidewall surface (130) of the container (100). In one embodiment, the flange attachment (160) comprises a sidewall (162) where, the sidewall defines a channel (163), a near opening (164), and a far opening (165). Interposed between the near opening (164) and the far opening (165), inside the channel (163), is a flange (166). For exemplary purposes, the flange attachment (160) is shown to be in the shape of a pipe. However, a person having ordinary skill in the art will understand that the flange attachment (160) can have any shape and size. The flange attachment (160), has an outside diameter slightly smaller than the inside diameter of a container so that the flange attachment (160) can be placed inside a container.

In another embodiment, the flange attachment (160) further comprises a means to attach (167) the flange attachment (160) to the substantially open portion of a container. The means to attach (167) can be a hook or any other kind of known attachment means. The flange attachment (160) has an outside diameter slightly smaller than the inside diameter of a container so that when the flange attachment (160) can be placed inside a container. The means to attach (167) is attached to the substantially open top portion of the container.

Prior to using the flange attachment (160) soil is placed into a container to a point just below where the flange (166) will lie. The flange attachment (160) is then placed into the container and soil is added above flange (166).

In each embodiment, the flange (150,166) extends towards the center of the container (100). However, the flange (150, 166) does not close the substantially open top (140) of the container (100). Preferably, the flange (150, 166) has an inside diameter that is at least 10% less than the inside diameter of the container (100). However, a person having ordinary skill in the art will understand that this number can vary depending on the shape of container, type of plant, type of soil, etc.

What is claimed is:

1. An apparatus for cultivating plants comprising a container having a base, substantially upstanding walls, interior sidewall surface, a substantially open top, and a flange; where the flange is interposed between the substantially open top and the base on the interior sidewall surface.

2. The apparatus of claim 1 further comprises a drain hole.

3. The apparatus of claim 1 where the flange extends toward the center of the container and does not close the substantially open top.

4. The apparatus of claim 3 where the flange is fixedly attached to the interior sidewall surface.

5. The apparatus of claim 3 where the flange is flexibly attached to the interior sidewall surface so that it can be repositioned to allow stacking of containers.

6. The apparatus of claim 5 where the flange is thin and flexible.

7. A method to use the apparatus of claim 1 comprises placing soil in the apparatus.

8. A method to use the apparatus of claim 1 comprises placing a plant in the apparatus.

9. A method to use the apparatus of claim 1 comprises watering a plant located within the apparatus.

10. A method to use a flange attachment comprising:
an apparatus having a side wall which forms a channel; where the side wall defines a near opening and a far opening; interposed between the near opening and the far opening is a flange;
where the apparatus is inserted into a container.

11. An apparatus having a side wall which forms a channel; where the side wall defines a near opening and a far opening; interposed between the near opening and the far opening is a flange.

12. The apparatus of claim 11 where the apparatus further comprises a means to attach the apparatus to the substantially open top portion of a container.

13. A method to use the apparatus of claim 11 comprises inserting the apparatus into a container.
